(19) United States
(12) Patent Application Publication
(10) Pub. No.: US 2026/0181601 A1
(43) Pub. Date: Jun. 25, 2026

(54) READER-TO-DEVICE FDMA FOR AMBIENT IOT

(71) Applicant: InterDigital Patent Holdings, Inc., Wilmington, DE (US)

(72) Inventors: Erdem Bala, East Meadow, NY (US); Senay Negusse, Montreal (CA); Kevin Wanuga, Souderton, PA (US); Martino Freda, Laval (CA); Paul Marinier, Brossard (CA); Aata El Hamss, Laval (CA); Moon IL Lee, Melville, NY (US); Jongwoo Hong, New York, NY (US); Remun Koirala, London (GB)

(73) Assignee: InterDigital Patent Holdings, Inc., Wilmington, DE (US)

(21) Appl. No.: 18/990,757

(22) Filed: Dec. 20, 2024

(51) Int. Cl. H04W 72/0446

(52) U.S. Cl. CPC H04W 72/0446

(57) ABSTRACT

Methods for frequency division multiple access in ambient internet of things (AIoT) systems are provided. A method includes mapping first and second groups of baseband symbols to a first one and a second one of a plurality of frequency subbands. The method includes processing the first and second groups of baseband symbols to generate a first signal, transmitting the first signal in first time resources, and determining that a first one or more devices are capable of receiving a transmission using one of the frequency subbands and a second one or more devices are not capable of receiving a transmission using one of the frequency subbands. The method includes transmitting data for the first one or more devices in different frequency subbands; and transmitting data for one of the second one or more devices in a single one of the frequency subbands.

### BACKGROUND

Transmission techniques for use in Ambient Internet of Things (AIoT) systems are being studied for standardization by the Third Generation Partnership Project (3GPP). The devices that are within the scope of study may have power consumption of about 1 μW to a few hundreds of μW. The devices may transmit using backscattering.

In backscattering, a device (also referred to herein as a “tag”) may reflect a received radio frequency (RF) signal after modulating the signal using a baseband signal. Baseband physical layer processing may use line codes for digital baseband modulation. In a line code, digital bits may be encoded into one or a sequence of pulses. For example, bit 1 may be encoded as a pulse with level +A and bit 0 may be encoded as a pulse of level 0. In this document A=1 is assumed without loss of generality. In another example, bit 1 may be encoded as a pulse with level +A and bit 0 may be encoded as a pulse of level −A. In yet another example, bit 1 may be encoded as a half-pulse with level 0 (or −A) followed by a half-pulse with level A and bit 0 may be encoded as a half-pulse with level +A followed by a half-pulse with level 0 (or −A). The latter encoding scheme may be known as Manchester encoding.

An IoT device may use backscatter modulation to transmit data to a receiver. In backscattering, a device does not generate an RF carrier but receives it from an external source and reflects the received RF signal. The baseband signal may be modulated on the reflected RF carrier. This may be achieved by using the impedance mismatch concept. An antenna impedance may be connected to a load impedance at the device. By changing the reflection coefficient (by adjusting the load impedance) over time, the amplitude, frequency, etc. of the reflected signal may be changed. For example, ON-OFF keying modulation may be achieved by using a non-reflecting state/OFF signal) and/or a reflecting state/ON signal. The EPC® Radio-Frequency Identity Generation-2 UHF RFID Standard specification describes procedures involving backscatter communications wherein RFID tags switch the reflection coefficient between two states based on the data being sent. ASK and PSK are supported by the RFID tags.

In some methods, digital bits may be encoded as a sequence of pulses without using a line code. For example, bit 1 may be encoded as a square wave over a finite duration with a first periodicity and bit 0 may be encoded as a square wave over a finite duration with a second periodicity, etc. One type of baseband processing method that may be used in RFID is subcarrier modulation. In this type of method, a subcarrier signal (e.g., a square wave) may be used to multiply the line coded signal. The multiplication may be achieved by a XOR operation (e.g., if voltage levels are unipolar) or scalar multiplication (e.g., if voltage levels are polar). The resulting signal may then be transmitted using backscatter modulation. In this document, except for the RF carrier signal, all signals discussed are baseband signals.

With subcarrier modulation, the spectrum of the line coded signal may be shifted in frequency wherein the shift may be determined by the chip duration of the subcarrier signal. Using this feature, transmissions from multiple devices may be multiplexed in frequency, e.g., by having devices perform subcarrier modulation using subcarrier signals corresponding to different frequencies. For example, a first device may modulate the codewords with a subcarrier signal with chip duration Tc while a second device may modulate the codewords with a subcarrier signal with chip duration 2×Tc. Another method to shift the spectrum of a Manchester encoded signal may be to reduce the codeword duration and repeat the codeword N times within a bit duration where N determines the amount of the frequency shift. In RFID communication, the D2R link data rate is determined by a parameter referred to as the backscatter link frequency (BLF), which also determines the bandwidth of the transmitted signal.

### SUMMARY

Methods for frequency division multiple access in ambient internet of things (AIoT) systems are provided. A method includes mapping first and second groups of baseband symbols to a first one and a second one of a plurality of frequency subbands. The method includes processing the first and second groups of baseband symbols to generate a first signal, transmitting the first signal in first time resources, and determining that a first one or more devices are capable of receiving a transmission using one of the frequency subbands and a second one or more devices are not capable of receiving a transmission using one of the frequency subbands. The method includes transmitting data for the first one or more devices in different frequency subbands; and transmitting data for one of the second one or more devices in a single one of the frequency subbands.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a signaling flow diagram illustrating steps performed according to one example of an inventory procedure;

FIG. 3 is a signaling flow diagram illustrating steps according to one example of a RACH procedure;

FIG. 4 is a diagram illustrating the concept of backscatter modulation;

FIG. 5 is a block diagram illustrating an example in which two subbands are used to generate a time-domain signal;

FIG. 6 is a diagram illustrating several examples of the transmission of preamble and RACH trigger messages;

FIG. 7 is a diagram including time domain representations of a composite signal and its component FDMA signals;

FIG. 8 is an illustration including time domain representations of two signals;

FIG. 9 is an illustration including time domain representations of a composite signal and its two component signals according to another solution; and

FIG. 10 is a flowchart illustrating one examples of a method as may be performed by a reader, which may be an AIoT reader or interrogator.

### DETAILED DESCRIPTION

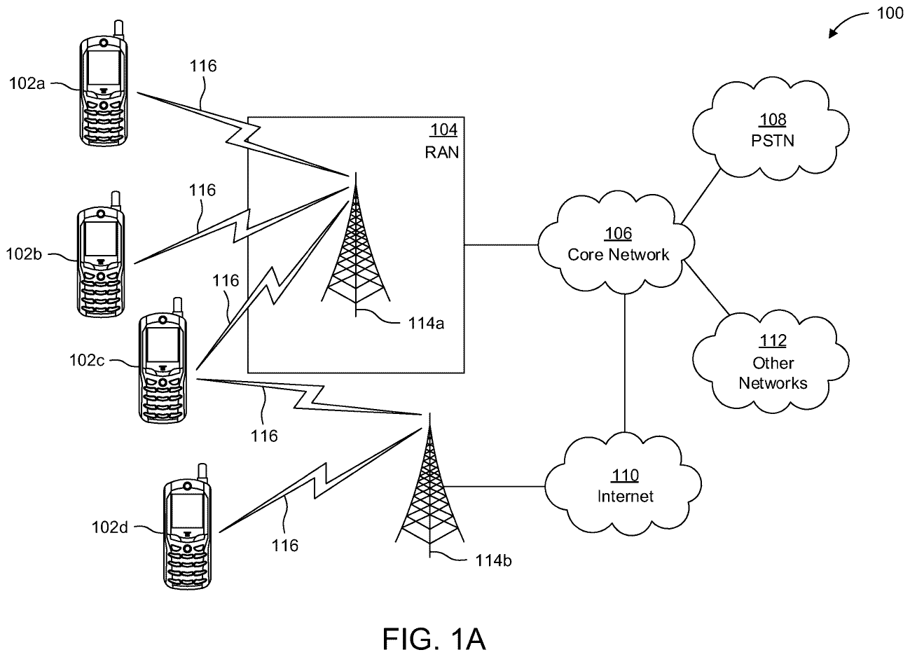

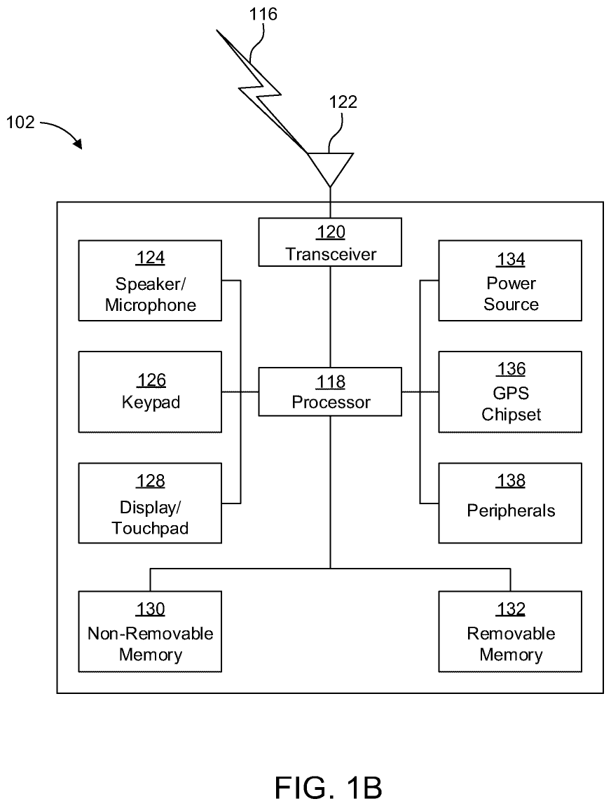

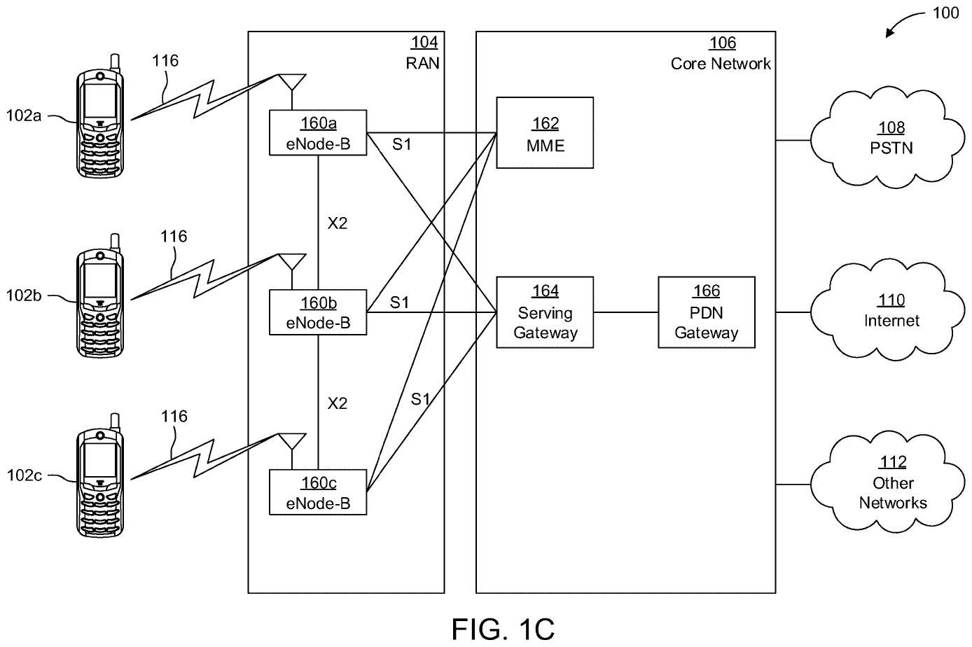

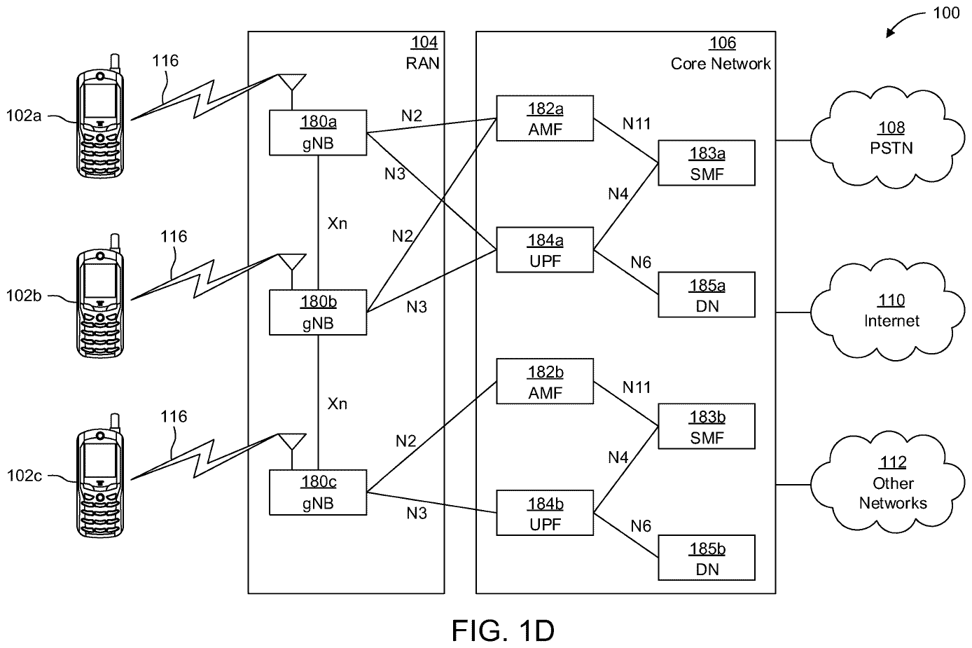

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Radio Frequency Identification (RFID) technology is commonly used for asset identification applications. A high-level summary of an inventory procedure from as may be carried out in an RFID system is provided in paragraphs below.

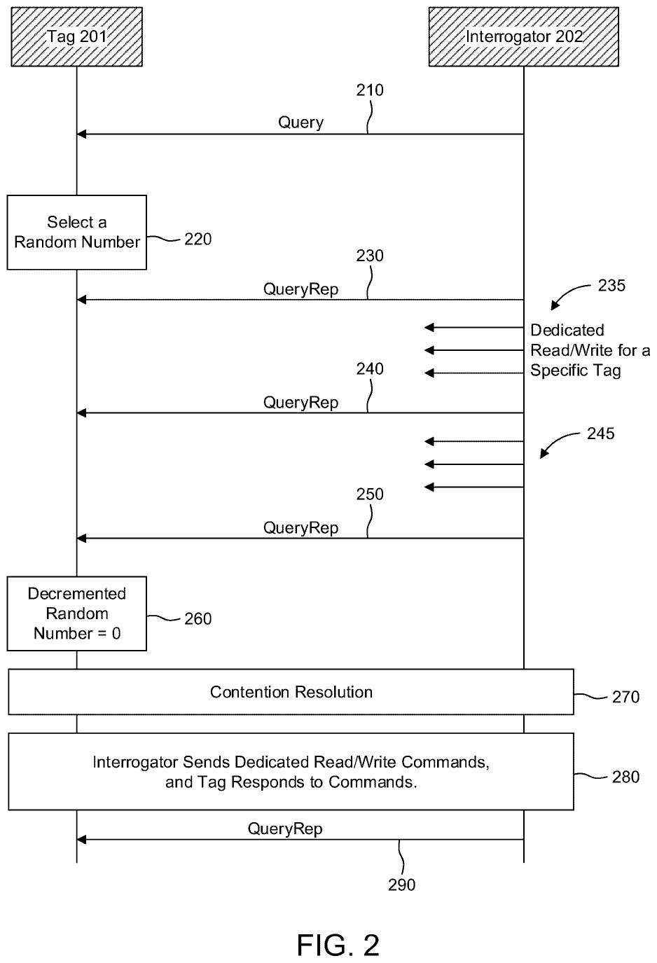

FIG. 2 is a signaling flow diagram illustrating steps performed according to one example of an inventory procedure. An RFID system as shown in FIG. 2 may include at least one interrogator 202 and one or more RFID devices 201 (also referred to herein as “tags”). In an inventory procedure, the interrogator (also known as a reader) may send a Query message 210 to energize all or a subset of tags. Following the Query message 210, a tag 201 selects a random number from 0 to 2^{Q-1} and stores the selected number in its memory as a counter, as shown at 220. The number Q is signaled in the Query message and determines the number of slots defined for the procedure. At 230, the interrogator 202 transmits the QueryRep message, possibly using multiple repetitions as shown at 230, 240, and 250. At each transmission of a QueryRep (which indicates a new slot), the tag 201 may decrement the counter stored in its memory until the counter reaches 0. As shown at 235 and 245 the interrogator 202 may be configured to send dedicated read/write commands to the tag 201. When the counter reaches 0 (i.e., the current slot is the slot device has randomly selected), as shown at 260, the tag 201 may initiate a contention resolution procedure which may include transmitting its device ID to the interrogator 202 and waiting for confirmation of the device ID from the interrogator 202. The interrogator may send a signal or a message to the tag confirming receipt of the device ID. This may help to address possible collisions between multiple devices that have selected the same random number. For a device that has passed the contention resolution step at 270, the reader may send multiple commands, to which the tag should respond, as shown at 280. As shown at 290, the interrogator 202 may send additional QueryRep messages to the tag 201, for example, as part of another procedure.

Random Access in Ambient IoT (AIOT) is described herein. In 3GPP AIoT systems, random access may be performed based on the steps described in the following paragraphs after a device determines its transmission occasion.

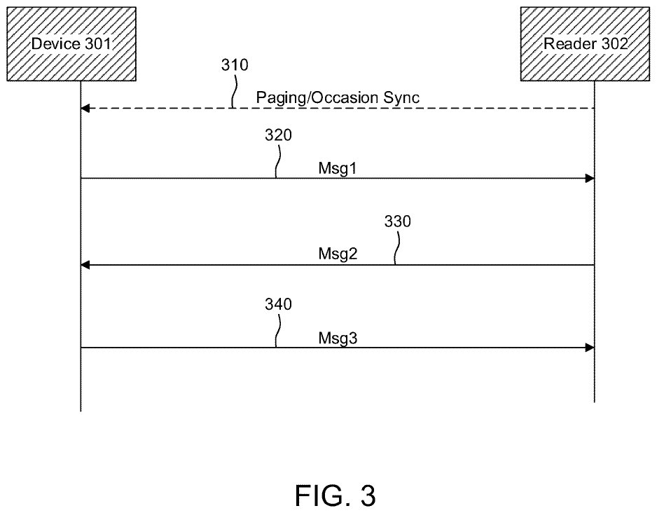

FIG. 3 is a signaling flow diagram illustrating steps according to one example of a RACH procedure. The RACH procedure shown in FIG. 3 may be performed by an AIoT device 301 and a reader 302 in a 3GPP AIoT system. At 310, the AIoT device receives a paging/RACH occasion synchronization message from the reader 302. The paging/RACH trigger message 310 may be used to select a device and/or indicate a new occasion (such as a slot as in RFID). Paging may also be transmitted before an inventory procedure (may be similar to Select and Query messages in RFID). In some examples, the AIoT device 301 transmits Msg1 to the reader 302 as shown at 320. Msg2 may include the AIoT device's random ID, which may be randomly selected by the reader substantially as described in paragraphs above.

At 330, the reader 302 may send Msg2 to the AIoT device 301. In doing so, the reader 302 responds to Msg1 received from the AIoT device 301 by echoing back the AIoT device's random ID. A 340, the AIoT device 301 sends Msg3 to the reader 302, which may include its random ID and/or application layer data.

A reader (which may be referred to as an interrogator), may be a base station (e.g., a gNB), a UE, a WTRU, or another type of wireless device. The methods described herein may not be limited to IoT devices performing backscattering, but may also be applicable to IoT devices that can generate an RF carrier (i.e., devices that do not require an external carrier), and other wireless devices.

The reader may use an On-Off Keying (OOK) modulated signal to transmit a baseband signal to a device. The baseband signal may be a line encoded signal. For 3GPP AIoT, for example, an OFDM-based OOK waveform with subcarrier spacing of 15 kHz may be used for Reader-to-Device (R2D) transmission. Device-to-Reader transmissions as described herein may be referred to as D2R. The physical channels between the reader and the device may be referred to as the PRDCH (Physical Reader-to-Device Channel) and the PDRCH (Physical Device-to-Reader Channel).

Problems addressed by the presented solutions are described in the following paragraphs. In some examples, applying FDMA in the Reader-to-Device channel may be desirable to increase system efficiency. To implement FDMA in R2D, the reader may transmit IoT signals targeting different devices on different subcarriers. An FDMA-capable device may be capable of filtering out signals on the undesired subcarriers. For example, for a number of device, k, a reader may transmit to k devices within a channel using k different subbands. On the other hand, a device that does not have such capability may be unable to use a subband-specific filter and may rely on RF envelope detection.

In addition, the reader may not know the types of the devices and a device may not have FDMA capability defined. One problem addressed herein may be how a reader may transmit to multiple devices using FDMA, when some of the devices may have FDMA capability and others may not. More generally, problems addressed herein may involve determining, for example, how a first device determines the capabilities of other (i.e., second) devices, how such second devices. As such, it should be understood that the discussion herein regarding how to implement FDMA in an AIoT system may constitute a specific implementation of a broader solution.

In accordance with some solutions, a device may be configured to transmit configuration information. In some examples, the configuration information includes an indication of one or more groups of subcarriers (e.g., one or more subbands) within a transmission channel. The configuration information may in some examples include an indication of the bandwidth of each group of subcarriers.

A description of proposed solutions is provided herein. Aspects common to multiple or all solutions are provided in the following paragraphs. Common terminology as may be applicable to one or more solutions is also described herein.

In the description provided, the terms device, IoT device, and tag may be used interchangeably to refer to an IoT device that is being inventoried/queried by the reader. The term reader may be used to refer to an entity that queries one or more AIoT devices. The term reader may refer to a network node, a base station, a UE, or a WTRU, depending on the context and/or the topology. Methods that are disclosed herein as being applicable to IoT devices may also be used by other wireless devices such as WTRUs.

Terminology and concepts relating to chips, symbols, and bits are described herein.

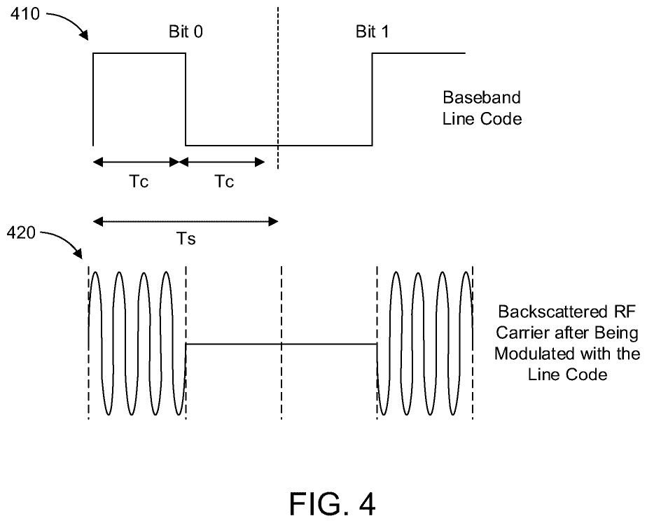

FIG. 4 is a diagram illustrating the concept of backscatter modulation. As shown at 410, using a line encoding scheme, bit 0 may be encoded as a pulse of amplitude 1 followed by a pulse of amplitude 0. Bit 1 is encoded as a pulse of amplitude 0 followed by a pulse of amplitude 1 (as previously mentioned line code is known as Manchester encoding). The bit (or symbol) duration is denoted as Ts. A chip may be defined as the smallest unit of pulse and the amplitude of a chip is assumed to be constant over the chip duration Tc. A symbol may include one or more chips. For example, as shown in FIG. 4, each Manchester symbol may include two chips.

As shown at 420, a baseband line code may be used to modulate a received RF sinusoidal carrier. In this example, the amplitude of the backscattered signal is changed depending on the value of the line code chip. For example, when a baseband chip has value 1, the received RF carrier is reflected as it is during the duration of Tc; when a baseband chip has value 0, the received RF carrier is absorbed by the device, and nothing is backscattered.

Terminology relating to an inventory procedure is described. In the detailed description provided herein, an inventory procedure may refer to the overall procedure of a reader triggering access by multiple devices using a sequence of messages (e.g., similar to a sequence of query, and query rep messages exchanged by RFID devices). Specifically, the inventory procedure may refer to a single round of attempts to have each device respond or attempt to respond with its access ID or perform a RACH procedure. In some examples, the inventory procedure may refer to a set of access occasions that may have 0 or at least 1 device respond within the access occasion.

Terminology relating to occasions is described herein. In the detailed description provided, an occasion may refer to an opportunity for device transmission that may be delimited by the transmission of a query rep message (or similar). Specifically, a device may perform a transmission in an occasion by performing a AIoT transmission in a defined time following the query rep associated with that transmission. Alternatively, an occasion may be defined in terms of both a time aspect and a frequency aspect. Specifically, a device may determine an occasion as a transmission following a specific query rep, and by transmitting on one of a number of frequencies (e.g., FDM). Solutions that refer to the selection of an occasion, may be applied equivalently to the selection of only a time component and/or selection of a frequency component.

Terminology relating to a time reference is described herein. Depending on the solution or example, a reference to time can be associated with an absolute time measurement (e.g., seconds, slots, frames, etc.). Alternatively, a time reference may refer to a number of executions of a procedure, possibly triggered by a reader (e.g., a number of inventory procedures, number of accesses or RACH procedures, etc.). Alternatively, reference can be made to a number of messages, possibly of a specific type, or containing specific information, as described herein, received or transmitted.

Terminology relating to a configuration is described herein. A configuration or pre-configuration may refer to parameters or settings that are determined, stored, transmitted or received by a device. A configuration or pre-configuration may be a configuration received by a message (e.g., an RRC message, a MAC CE, a PHY layer signal, a data PDU, a control PDU associated with any or a new protocol layer, etc.) received from, for example, base station, a network node, or from another device or WTRU.

A device herein may be configured by a reader, whereby the reader may be a network node or a WTRU. In the case of a WTRU, the WTRU may derive the device configuration itself, or receive the device configuration from the network, in which case, the device configuration is being relayed from the network to the device by the WTRU. On the other hand, a UE configuration may be received from a network node (e.g., a base station such as a gNB).

FDMA operation is described in further detail herein. In some examples, an OOK signal may generated using an OFDM modulator. In some examples, baseband symbols (e.g., 1s and 0s) may be first processed by a DFT block and the output (or part of the output) of the DFT may be mapped to an IDFT block wherein an input of the IDFT corresponds to a subcarrier (a resource in frequency domain). A set of subcarriers may be referred to as a subband. For example, the DFT size may be M and the IDFT size may be N in which case M outputs of the DFT may be mapped to M inputs of the N-size IDFT. The spectrum of the time domain signal may be determined from the subcarriers used. In some methods, the reader may receive an indication to, or determine to, use two or more subbands to generate a time domain signal.

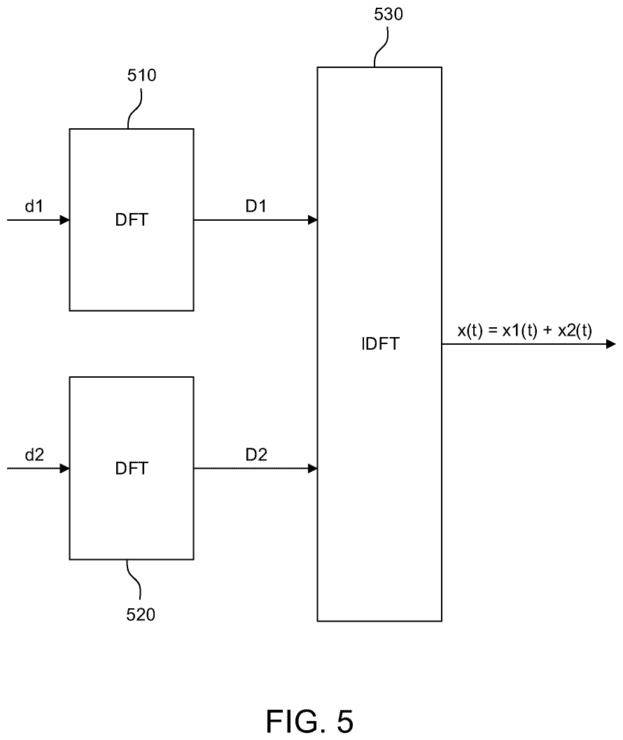

FIG. 5 is a block diagram illustrating an example in which two subbands are used to generate a time-domain signal. As shown in FIG. 5, symbols d1 are processed by a DFT block 510, and the DFT output D1 may be an input to a first subband wherein the time domain signal corresponding to d1 may be denoted as x1(t). Similarly, symbols d2 may be processed by a DFT block 520 and the DFT output D2 may be an input to a second subband wherein the time domain signal corresponding to d2 may be denoted as x2(t). As shown at 530, the DFT outputs D1 and D2, which are mapped to the first and second subbands, respectively, are processed by the IDFT block. The output of the IDFT block as shown in FIG. 5 may be a composite time domain signal. Due to the linearity property of DFT and IDFT, a composite time domain signal may be referred to as x(t) wherein x(t)=x1(t)+x2(t). A composite signal x(t) may further be upconverted to a RF carrier frequency such as a 900 MHz carrier before being transmitted.

By choosing the inputs d1 and d2 properly, x1(t) and x2(t)may be generated as OOK signals. If x(t) is generated using a single subband, then the output signal x(t) may not be a composite signal (for example, x(t)=x1(t), or x(t)=x2(t)), and a device using RF envelope detection may be able to detect this signal. However, if the composite signal includes a plurality of signals (e.g., corresponding a plurality of subbands), then such device may not be able to detect the embedded data since the composite signal may not be OOK modulated anymore, and the device may not have the capability to filter out only the desired subband and receive the signal transmitted on that subband. Such as device may be referred to as non-FDMA device. Another type of device, referred to as an FDMA device, may be able to filter out only the desired subband and receive the signal transmitted on that subband. For example, a device A may filter out subband 1 to receive x1(t) and a device B may filter out subband 2 to receive x2(t).

In some solutions, in a first set of time resources a reader may determine to transmit to devices using FDMA and in a second set of time resources the reader may determine to transmit to devices using non-FDMA. A time resource may be a slot, a group of slots, an inventory round, or another type of resource. The methods described herein may be applied similarly to any type of time resource. In time resources where FDMA is used (which may be referred to as FDMA time resources, FDMA slots, for example) the reader may generate and transmit a signal using at least two frequency subbands wherein the data/information/signal transmitted in different subbands may be intended for different devices. In time resources when non-FDMA is used (may be referred to as non-FDMA time resources, non-FDMA slots, etc.) the reader may generate and transmit a signal using one frequency subband wherein the data/information/signal transmitted in the subband may be intended for a single device. Without loss of generality, the first set of time resources may be referred to as non-FDMA slots and the second set of time resources may be referred to as FDMA slots.

In FDMA slots, a transmitted composite signal may include a plurality of individual signals wherein each individual signal may be associated with a frequency resource. The frequency resources associated with individual signals may not be overlapping. It should be noted that signals may almost always overlap in frequency, but the main part of a signal may only experience a small amount leakage from the other signals). For example, a 5 MHz channel may be divided into five subbands and five individual signals may be generated using each of the five subbands. The transmitted signal may be the addition of the five individual signals.

A composite signal may be a signal comprising individual signals wherein each individual signal may be associated with a subband. It should be noted that although some examples described herein may refer to the use of two subbands and/or devices, the number of subbands and/or the number of devices served in one time source may be less than or greater than two.

A first group of devices may be capable of separating the individual signals in a composite signal. For example, such devices may receive the composite signal, down convert the composite signal to baseband, filter the desired subband and detect an individual signal associated with the subband. On the other hand, a second group of devices may not be capable of separating the individual signals in a composite signal. The first group of devices may be referred to as FDMA capable devices and the second group of devices may be referred to as non-FDMA capable devices. It should be noted that FDMA-capable devices may also be capable of receiving non-FDMA signals.

Solutions involving test signals for R2D FDMA-based methods are described herein. In some solutions, devices may be classified based on whether they are capable of successfully receiving a test signal and or a test message. In some examples, the term “successfully receiving” may be interpreted as detecting a signal, such as a preamble. In some examples, the term “successfully receiving” may be interpreted as receiving and/or decoding a message. For example, a receiver may be said to successfully receive a message if the receiver receives a message and determines that (e.g., by checking the CRC) there were no errors. In the description provided herein, a test signal may refer to a signal, a message, and/or a transmission and the solutions may be applied similarly. In the description provided herein, the phrases “receiving a signal” and “detecting a signal” may be used interchangeably. A test signal/message may be referred to in some examples, as a measurement signal, a sequence, a preamble, a preamble sequence, or simply as a signal or a message.

In general, a reader may generate and transmit a test signal. The test signal may be detectable by a first group of devices and the test signal may not be detectable by a second set of devices. In some examples, a reader may generate a test signal using more than one subband. In examples where FDMA is implemented, this type of signal may be referred to as an FDMA signal or an FDMA test signal herein. In some examples, the reader may generate a test signal using one subband. This type of signal may be referred to as a non-FDMA signal or a non-FDMA test signal. An FDMA capable device may be capable of receiving both signals and a non-FDMA capable device may only be capable of receiving the non-FDMA signal. In other words, a non-FDMA capable device may be incapable of receiving the non-FDMA signal. In the description provided herein, it may be assumed that the test signal is generated as an FDMA and/or non-FDMA signal but solutions may apply to test signals generated using other approaches (for example, other multiple access approaches such as CDMA).

Further aspects relating to device classification are described herein. In some solutions, a reader may identify and/or classify a set of devices based on their capability to detect a test signal. For the reader to achieve the classification, one method may be for the reader to transmit a test signal.

The test signal/message may be such that only a subset of devices (e.g., FDMA capable devices, in certain examples) may be able to detect the signal. For example, the signal may be a composite signal and may comprise signals that are separately generated. For example, the signals may be separately generated using multiple frequency subbands. An FDMA capable device may detect/receive this signal. As an example, the reader may determine to use a first set of subcarriers (e.g., a first frequency subband) to transmit a first signal (e.g., a first set of preamble sequences) and determine to use a second set of subcarriers (e.g., a second frequency subband) to transmit a second signal (e.g., a second set of preamble sequences). FDMA capable devices may be able to separate the set of preamble sequences transmitted in the first and second frequency subbands (e.g., using a filter) and detect the set of preamble sequences from one or both frequency subbands. It should be noted that the first and second set of preamble sequences transmitted in the first and second frequency subbands may be the same or different sequences. In some examples, instead of a signal, the reader may send a message in a frequency subband, wherein the message may be encoded with a channel encoder and/or protected with a CRC. An FDMA capable device may be able to receive one or more of the messages.

A non-FDMA capable device may not be expected to receive/detect such a signal/message since such device may not be able to separate individual signals/messages.

In some solutions, the reader may transmit one signal and a portion of the signal may be detectable by all devices and portion of the signal may be detectable by a subset of the devices only (e.g., FDMA capable devices).

In some solutions, the reader may transmit more than one test signal, and a first test signal may be detectable by a first set of devices. A second test signal may be detectable by a second set of devices. For example, the reader may transmit two test signals wherein one signal may be detectable by all devices while the second signal may be detectable by FDMA capable devices only.

In some examples, a test signal may be generated by a reader to test at least one device capability. In some examples, the device capabilities may refer to capabilities besides FDMA. For example, a capability may be defined in terms of inter-message time differences. In some cases, the test signal could include a first part and a second part, where a time difference between the two parts determines the inter-message decoding capability. In one specific example, if two messages are separated by x seconds, the devices that receive the two messages correctly may be able to participate in a random access procedure where the time difference between messages is equal to X.

In some cases, a capability may be defined in terms of a reader transmission power or distance from the reader: A test signal may include a signal or information indicating a specific transmit power.

In some cases, a capability may be defined in terms of an ability to decode control information. For example, control information (e.g., in a MAC CE) can be included in the test message, and if properly decoded, the device may participate in an inventory round where control information is included in the R2D messages.

In some examples, a reader may be configured to determine at least one device capability. For example, the reader may be configured to determine a capability of one or more devices based on a capability information exchanged. For example, the reader may determine the capabilities of one or more devices with which it has performed an inventory procedure. The reader may store information associated with the capabilities of one or more devices and use the stored capability information to determine methods or parameters of communicating with the devices. In some examples, the reader may be configured to determine the capabilities of one or more devices implicitly. For instance, the reader may determine the capabilities of one or more devices based on responses received (or not received) from the devices in response to test signals that the reader (or another type of device) has transmitted.

In some examples, a set of test signals transmitted by the reader may include a train of pulses (e.g., a pulse wave) each of which may have different pulse periodicity, pulse width and amplitude. In some examples, a non-FDMA device may expect to detect a train of short pulses with a receive signal strength above a configured threshold whereas an FDMA capable device may experience a received signal strength below a configured threshold for the same set of short and periodic pulses. On the other hand, an FDMA capable device may detect the train of pulses with wider pulse width with a received signal strength above the configured threshold whereas a non-FDMA device may detect the same set of pulses with a received signal strength below a configured threshold.

In an additional example, the set of test signals generated by the reader may include a set of orthogonal narrow band (e.g., single tone sinusoidal) signals transmitted simultaneously across multiple contiguous frequency subbands where each frequency subband contains the same, T, number of orthogonal narrow band signals. In such a case, an FDMA capable device may be able to tune its filter and detect at most T number of orthogonal signals in at least one of the subbands. On the other hand, a non-FDMA device may not be capable of tuning to any one or more of the narrow band signals and will not be able to detect anyone of the multiple narrow band signals across the multiple subbands.

A device may determine if a test signal was detectable, or the test signal was not detectable. In some solutions, the device may store this information, e.g., in memory, for example using a n-bit flag wherein n may be the number of test signals. For example, the device may set a flag to 1 if the device was able to detect a test signal and may set the flag to 0 if the device was not able to detect the test signal. In another example, the device may keep two bits and may set each of the two bits based on the detection outcome of two test signals. For example, if the first signal is a non-FDMA signal and the second signal is a FDMA signal, a non-FDMA device may set the bit corresponding to the first signal to 1 (assuming successfully detected) and the bit corresponding to second signal to 0 (assuming was not detected). In the same example, an FDMA capable device may set both bits to 1 (assuming the FDMA capable device is capable of detecting both FDMA and non-FDMA signals, and assuming that both the non-FDMA and FDMA signals were detected).

In the subsequent transmission, the reader may select a subset of the devices based on whether the devices were able to detect a test signal. It should be noted that in this case the reader may not need to explicitly know which devices were able to detect a test signal. In some solutions, the reader may send a select message (for example, a select message that is part of a paging message) that may include a possible outcome/result of a test signal. A device, upon receiving the select message, may compare the indicated outcome/result to the outcome/result it has obtained (e.g., via the test signal). If the indicated and actual outcomes/results are identical, then the device may determine it has been selected by the reader.

For example, the reader may transmit a test signal and a first set of devices that are able to detect the test signal may set a flag to 1 and a second set of devices that are not able to detect the test signal may set a flag to 0. Subsequently, the reader may indicate in a select message bit-1 to select the first set of devices or bit-0 to select the second set of devices. In some examples, a device may determine a n-bit flag based on the measurement of a plurality of test signals, and the reader may then send an n-bit indication to select those devices that have determined the same n-bit outcome/result. It should be noted that the described steps involving setting a flag may merely refer to a specific implementation, and those of ordinary skill in the art will appreciate that a device may use other methods to keep a determined outcome/result of a measurement of a test signal.

In some examples, a reader may send a test signal, and the test may be an FDMA signal. Devices that detect/receive the signal may set a flag to 1 and devices that do not detect the signal may set a flag to 0. The reader may then a select message and indicate in the select message a possible outcome of the test signal as determined by a device. The reader may use a 1-bit indication in the select message. For example, if the indicated bit is 1, devices that have the flag set to 1 may determine they have been selected and, if the bit is 0, devices that have the flag set to 0 may determine they have been selected. The selected set of devices may be allowed to continue communication with the reader. For example, the selected devices may determine to join an inventory round associated with the select message. In the subsequent communication, the reader may generate and transmit signals such that the selected devices are able to receive the transmitted signal. For example, if FDMA capable devices are selected to join the inventory round, during the inventory round the reader may transmit on the same time resources to more than one device wherein the transmissions to multiple devices may be multiplexed in frequency (e.g., multiple subbands are used and each subband carries data for one device). On the other hand, if non-FDMA devices are selected, the reader may not apply FDMA in the corresponding transmission.

In some methods, a reader may allocate time domain resources (e.g., slots in an inventory round) to specific set of devices. For example, if there are N slots in an inventory round, the reader may indicate to the devices that a subset of the N slots may be allocated to devices with a specific determined outcome/result. More specifically, in some solution, the reader may indicate for each slot (e.g., in a QueryRep like message) a desired outcome/result. A device that compares the actual outcome/result to the indicated one and determines the actual outcome/result is identical to the indicated outcome/result may be allowed to transmit and/or receive (i.e., determine it is permitted to transmit and/or receive) in the associated time/frequency resource.

The number of subbands, and/or location of the subbands in frequency, the subbands loaded with test signals, and any other information needed to detect/receive the signal/message may be indicated to the devices by the reader and/or determined by the device. For example, the reader may transmit configuration information (e.g., in a message) and the configuration information may be decodable by all devices.

A device may receive information regarding one or more subbands. A device may try to detect signal(s) in some or all subbands. In some examples, a device may randomly select one or more subbands and attempt to detect (i.e., attempt to decode) signals in the randomly selected subbands.

In some solutions, devices may determine an outcome or result based on a test signal and feedback the result to the reader, for example in a message (e.g., msg1). The feedback may include at least one bit. The feedback may be transmitted in an initial transmission, e.g., in a msg1, or in a subsequent transmission as part of a RACH procedure. In some solutions, a parameter of an initial transmission may be determined based on the outcome of the test signal. For example, a first preamble of a msg1 may indicate the device successfully detected the test signal while a second preamble of a msg1 may indicate that the device did not successfully detect the test signal. A device may transmit a signal or a message providing an indication to the reader that may indicate (a) that the device successfully detected at least one of the test signals/messages received, e.g., in a composite signal; or (b) that the device successfully detected all of the test signals/messages received, e.g., in a composite signal. The reader may use this indication to schedule transmissions to or from the devices accordingly.

Different time resources, e.g., slots in a slotted ALOHA framework, occasions indicated by QueryRep, etc. may be allocated for devices with different capabilities. An indicator for the start of a time resource may indicate explicitly that the given resource is available only for FDMA capable devices, available only for non-FDMA capable devices or available for both FDMA and non-FDMA capable devices. Alternatively, or additionally, an R2D message indicating the beginning of a set of time resources, e.g., an R2D message initiating an inventory procedure, or a trigger indicating the beginning of a set of slotted ALOHA slots may include a schedule of slot availability for a set of N time resources. As an example, the initiating message may indicate that the first M time resources are available for non-FDMA capable devices and the remaining N−M time resources are available for FDMA capable devices. The devices selecting their slot for random access may identify the slot classification based on monitoring and counting indicators for the beginning of each slot.

Time resource classification may also be indicated on a slot-by-slot basis through the use of a bitmap field at the beginning of a set of time resources. As an example, a bit field with a value 0 in a bit map may indicate that the indicated time resource is reserved for non-FDMA capable devices while a bit field with a value 1 in the bit map may indicate that the time resource is for FDMA-capable devices.

A non-FDMA capable device may detect an indication of a time resource for transmission of a message (e.g., random-access msg1) by a non-FDMA capable device in a first subband. The time resource may be dedicated for either non-FDMA capable devices only or for both non-FDMA and FDMA capable devices. An FDMA capable device may detect both an indication for the time resource for transmission of a message (e.g., a random access msg1) by a non-FDMA capable device in the first subband and also a separate signal for FDMA capable devices for a time resource for transmission of a message (e.g. random-access msg1) by an FDMA capable device in another subband.

An FDMA capable device may transmit a message (e.g., random-access msg1) in the time resource in the first subband. The transmission may include an indication that it detected the indicator for the other subband. The reader may, for example, transmit msg2, an random-access response, in the first subband or alternatively transmit the msg2 in the other subband.

A FDMA capable device may transmit a message (e.g. a random-access msg1) in the time resource indicated by the indicator for the other subband identifying it as an FDMA capable device. The reader may, for example, continue the random-access procedure by transmitting the msg2 transmission in the other subband.

Solutions involving an implicit indication based on RACH trigger detectability are described herein. In some methods, a RACH trigger message transmitted by the reader may be associated with a set of time and/or frequency resources. These resources may be used by the reader and at least a device for communication, e.g., transmission and/or reception in R2D and D2R directions. For example, a paging or a Query message may be associated with an inventory round that may include a plurality of slots. In another example, a QueryRep message may be associated with a slot.

In some solutions, the reader may transmit a signal/message and a device that detects the signal/message may receive the associated subsequent R2D transmission and/or may determine to transmit to the reader in the associated resources. For example, the reader may transmit a RACH trigger signal/message (such as a message similar to QueryRep, a paging message, or another message). A device, upon receiving the trigger message, may determine to transmit and/or receive in the associated slot(s). In the same example, if a signal/message that is part of the RACH trigger signal/message is not detected by a device, then that device may not join the subsequent communication. For example, a preamble preceding the QueryRep message and/or the QueryRep message may not be detectable by non-FDMA devices and those devices may not be expected to receive/transmit in the associated slot(s).

A reader may transmit a configuration message that may include parameters needed by a first device to receive a message and/or a signal. For example, a preamble that precedes a R2D transmission may be generated using k subbands (by the reader) and the configuration message may include configuration information associated with the subband parameters (e.g., the number of subband, which subbands carry a signal, etc.). In some examples, a RACH trigger message (e.g., a Query-like message, a QueryRep-like message, a paging message) may be generated using k subbands (by the reader) and the configuration message may include configuration of the subband parameters. For example, a QueryRep message may be repeated in two subbands and since only FDMA capable devices may be able to receive the message, those devices may be able to join the inventory round in the associated time resource.

In some solutions, the initial configuration message may be decodable by all devices. In some solutions, the initial configuration message may be decodable by a subset of the devices and parameters may be specified.

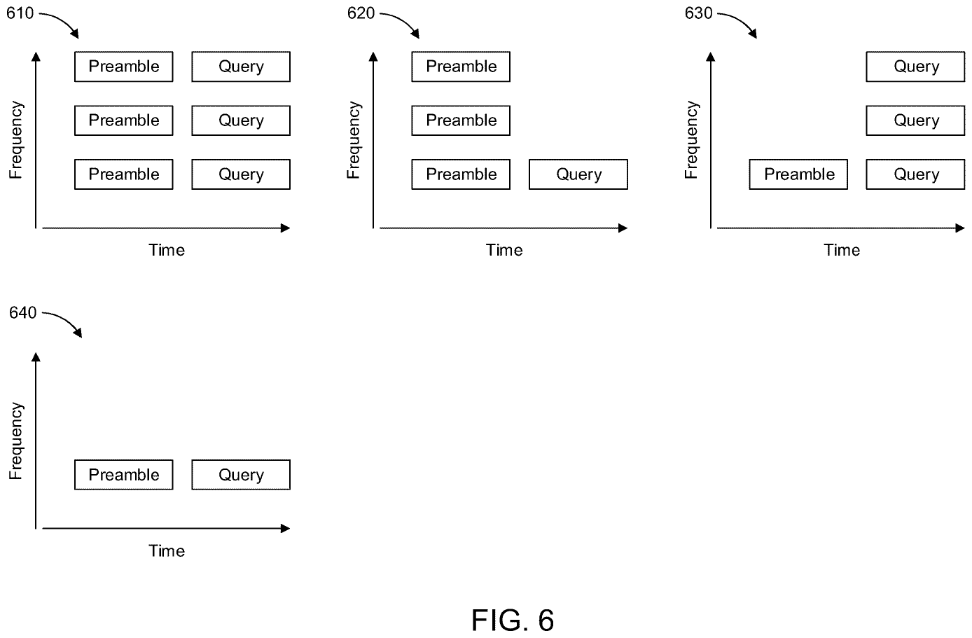

FIG. 6 illustrates several examples of the transmission of preamble and RACH trigger messages. Specifically, in FIG. 6, different scenarios 610, 620, 630, and 640 are illustrated. In scenarios 610, 620, and 630, the preamble and/or the RACH trigger message (e.g., a Query or paging message) are generated by the reader using a plurality of frequency subbands. For example, as shown in scenario 610, the same preamble and Query message may be repeated in separate subbands. Furthermore, in scenarios 620 and 630, either the preamble or the Query message are repeated in different subbands. In such cases, the preamble and/or Query message may be detected only by FDMA capable devices in such scenarios. Therefore, in subsequent resources associated with a given Query message, it may be that FDMA capable devices may transmit and/or receive. One can say that FDMA capable devices are implicitly selected by the reader. In scenario 640, since a single subband is used, non-FDMA devices may receive an indication to join the subsequent communication. It should be noted that a configuration stored at the reader may provide that FDMA capable devices are not allowed to transmit or receive in the associated resources. It should be understood by those of skill in the art that RACH trigger messages are not limited to the examples shown in the FIG. 6 and/or described above. For example, the RACH trigger message may be a QueryRep message in some instances. In other examples, the RACH trigger message may be replaced by a message of a different type while the methods and procedures described above and illustrated in FIG. 6 may remain the same.

In some examples, the reader may transmit a same message at least in two different formats such that a first set of devices (e.g., one or more devices) may be able to receive the message in all of the different formats, while another set of devices (e.g., a different one or more devices) may only be able to receive the message in one of the different formats. In some examples, a first set of devices may be able to receive the message in one of the different formats, while another set of devices may only be able to receive the message in another one of the different formats. In some examples, when a reader transmits the same message in different formats, the reader may (or may not) use different resources or parameters to transmit the messages in different formats. In some examples, the transmission of a “same” message in different formats may be interpreted to mean that the message type, rather than the message contents, are the same. In some examples, the transmission of a “same” message in different formats may be interpreted to mean that the message contents, rather than the message type, are different. In some cases, the message type may refer to a Query message, a select message, a paging message, a QueryRep message, or another type of message.

A format of a message may be defined by one or more characteristics. For example, a format of a message may determine how many subbands are used to generate the message. For example, as illustrated in FIG. 6, the scenarios 610, 620, 630 involve the use of three subbands. In the scenario 640, one subband is used. Thus, it may be interpreted that a first format may correspond to the format shown in scenarios 610, 620, 630, while a second format may correspond to the format shown in scenario 640.

In some examples, a format of a message may determine how many subbands are used to generate the preamble preceding the message. A format of a message may determine how many subbands are used to generate at least one component of the message.

A format of a message may determine the channel coding for a message. For example, a first format may be correspond to a channel coded message while a second format may correspond to a message with no channel coding applied.

In some example, a message may be interpreted as a signal, for example a preamble signal and/or a start indicator signal. The signal may precede a message such as a RACH trigger message, or another R2D message. A format of a message may determine a signal parameter. For example, two different preambles may be used for two different formats. The signal format may determine the sequence used to generate the preamble, the line code used to generate the signal, the length of the signal, the chip duration of the signal, the number of subbands used to generate the signal.

A message may be transmitted by the reader to implicitly select a set of devices such that only devices that are capable of detecting and/or decoding a message with a specific format may continue with subsequent transmission/reception. For example, the reader in a first time and/or frequency resource may transmit a first preamble (e.g., having a first format) preceded by a RACH trigger message (such as a paging message, a Query message, a QueryRep message, or another type of message). Devices that are capable of detecting the first preamble may receive the RACH trigger and determine to initiate a transmission to the reader by sending a msg1. Devices that cannot detect the first preamble my determine not to initiate transmission to the reader. The reader then in a second time and/or frequency resource may transmit a second preamble (e.g., using a second format) preceded by a RACH trigger message. Devices that are capable of detecting the second preamble may receive the RACH trigger and determine to initiate transmission to the reader by sending a msg1. Devices that are not capable of detecting the second preamble may determine not to initiate transmission to the reader. In some examples, the preamble may be detectable by all devices but the subsequent RACH trigger message may be detectable by only a set (e.g., a subset) of devices based on the format of the RACH trigger message.

In some examples, the reader may transmit a signal/message in all of the available subbands, in a subset of the available subbands (e.g., in at least two randomly selected subbands), or in subbands that are configured/signaled by the network.

A reader may transmit a signal indicating a time resource available for random access. This signal may consist of a composite of a signals occupying different subbands. One subband may be considered as a “default” subband in which either only non-FDMA capable devices or both non-FDMA and FDMA capable devices may transmit Msg1 to initiate a random access attempt. At that same time instant, in another subband, a component of a composite signal may be transmitted. This component signal may only be detected by FDMA capable devices. The component signal may indicate a separate time and frequency resource available for FDMA capable devices. This resource may overlap partially or entirely with 1 or multiple “default” resources in time but on a separate subband.

Aspects relating to FDMA signal design are described herein. In some methods, a reader may generate one or a plurality of OOK modulated signals. The signals may be encoded using a line encoding scheme such as Manchester encoding. The reader may generate an OOK signal using an OFDM modulator.

In the description provided in the following paragraphs, it may be assumed that Manchester line coding is assumed. The signal transmitted by the reader may be a composite signal that includes a plurality of generated signals.

In some solutions, a reader may generate a first Manchester encoded signal, where a chip duration of the first signal may be denoted as Tc. The reader may also generate one or more of a second Manchester encoded signal wherein the chip duration of the one or more of the second signal may be n×Tc, wherein n may be an even integer (e.g., n=2).

The reader may use non-overlapping frequency resources to generate the signals. For example, a channel may comprise k non-overlapping frequency subbands. If an OFDM transmitter scheme is used for signal generation, the reader may use a first subband to generate the first signal, a second subband to generate a second signal, a third subband to generate another second signal, etc.

In some cases, the spectrum of the signals may overlap. However, the main lobes of the signal may be non-overlapping. In general, the spectrums should be such that it may be possible by a receiver to filter out a specific subband to receive a signal generated using the corresponding frequency resources.

In one method, the line coded signals may be generated such that at the time instant in the middle of a Manchester codeword where a rising or falling edge occurs (for the first signal), the second signal may have a constant chip amplitude (e.g., no rising or falling edge). In one method, this may be achieved by setting the chip duration of the second signal as n×Tc where n is an even integer. The signals may be synchronized such that one Manchester codeword of the first signal overlaps with one chip of the second signal. The first signal may be detected by a non-FDMA device, and the second signal may be detected by a FDMA device.

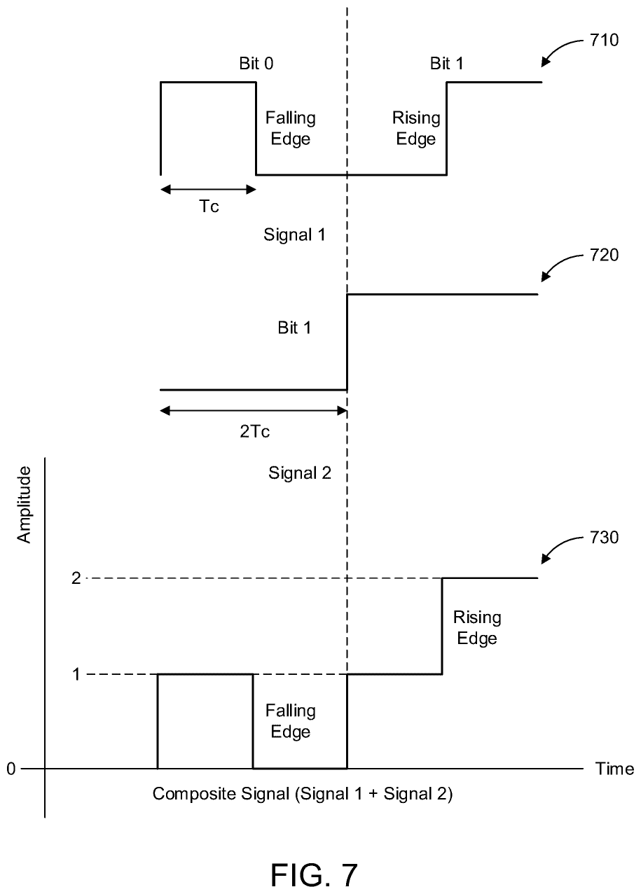

FIG. 7 is a diagram including time domain representations of a composite signal and its component FDMA signals. As shown in FIG. 7, a composite signal 730 is composed of two components, Signal 1 and Signal 2, denoted in by elements 710 and 720, respectively. Signal 1 and Signal 2 are generated by using two different subbands. An FDMA capable device may filter the subbands and receive Signal 2. A non-FDMA device may use the composite signal to receive the data transmitted using Signal 1. As illustrated by the time domain representations 710 and 730, Signal 1 and the composite signal may have similar edges (i.e., rising or falling edges) which can be used by a non-FDMA device to detect the data bits. It should be noted, even if Signal 1 and Signal 2 do not have over lapping edges (rising or falling), Signal 2 and the composite signal may also have similar edges (rising or falling) and, hence, Signal 2 may be received by an FDMA capable device in a similar manner as the non-FDMA device by detecting the corresponding edge transition.

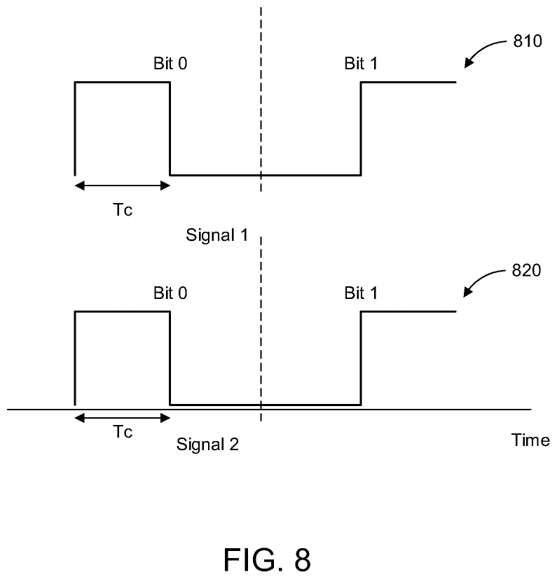

The devices may need to be trained to estimate at least the chip duration and/or the signal levels between the rising/falling edges. For example, as shown by the time domain representations 710, 720, and 730, the possible signal levels are 0, 1, and 2. To facilitate training of the devices, the reader may send a training sequence (e.g., a preamble) that may include at least a signal generated using a single subband, and a composite signal. FIG. 8 is an illustration including time domain representations of two signals. In FIG. 8, the propagation of Signal 1 and Signal 2 over time are shown by the representations 810 and 820. In some methods, a reader may generate the two signals using the same chip duration but with an offset in time, as shown in FIG. 8. The offset may be, for example, a half chip duration. The offset may be used so that the rising/falling edges of Signal 1 do not change when the signals are superimposed to generate the transmitted composite signal.

In some examples, a reader may generate two or more sequences of Manchester codeword signals with the same chip duration, where the start and edge of each chip is perfectly aligned. Each OOK signal may be overlaid/modulated with orthogonal set of sequences and/or waveforms (e.g., square wave, sinusoidal wave) and transmitted simultaneously across one or multiple subbands. Based on the orthogonal sequence and/or waveform it is configured to apply, a non-FDMA device may be able to detect the signal addressed to it, employing a correlator, for example.

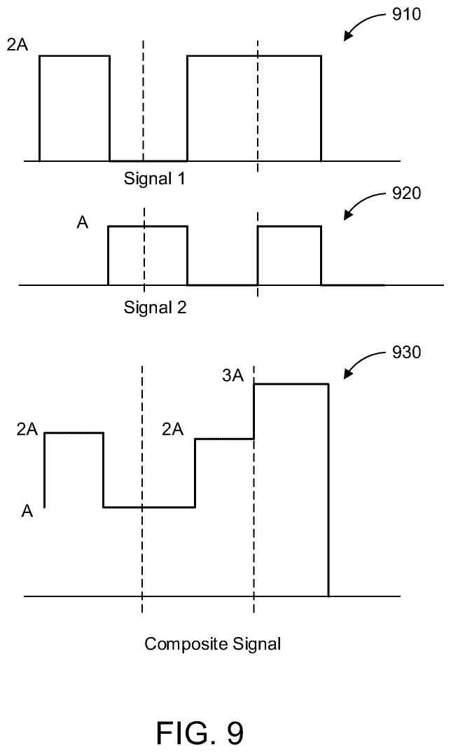

FIG. 9 is an illustration including time domain representations of a composite signal and its two component signals according to another solution. As shown in FIG. 9, three Manchester codeword signals, Signal 1, Signal 2, and the composite signal of Signal 1 and Signal 2 are illustrated respectively by time domain representations 910, 920, and 930. As shown in FIG. 9, Signal 1 may have a different amplitude range than Signal 2. For Signal 1, a baseband chip amplitude of value 1 has a different amplitude (e.g., 2A) compared to the value 1 baseband chip amplitude (e.g., A) of Signal 2. A non-FDMA device may be able to detect Signal 1 by employing a set of energy thresholds. The energy thresholds may be used for detecting the start of a chip, as the chips may be detectable when the amplitude is above A belonging to Signal 1 and the associated edge. The set of energy thresholds may configured based on the difference in the amplitudes used for value 1 chips in Signal 1 and Signal 2. Additionally, or alternatively, a non-FDMA device may be able to detect Signal 2 by employing a set of energy thresholds in a similar manner.

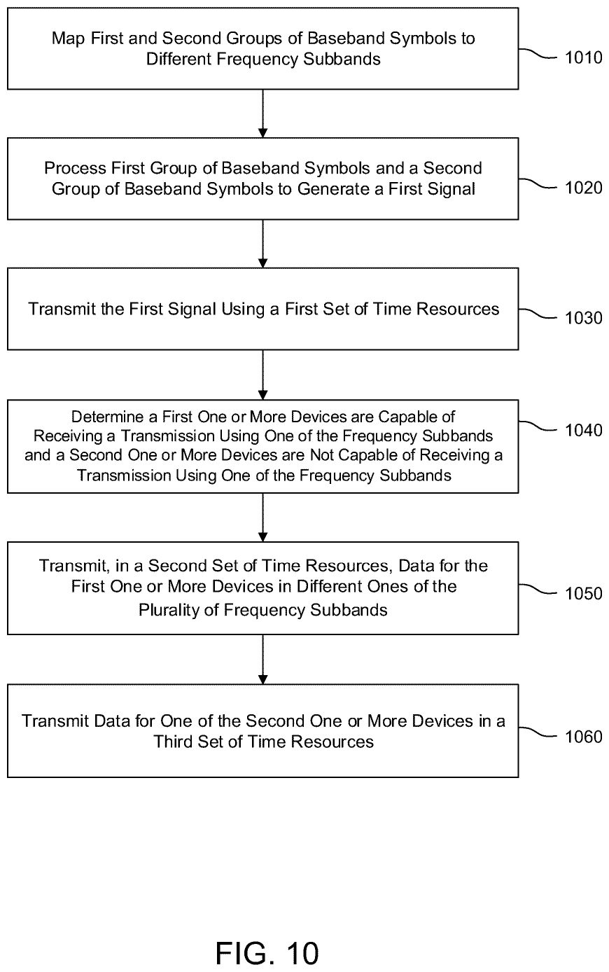

FIG. 10 is a flowchart illustrating one examples of a method as may be performed by a reader, which may be an AIoT reader or interrogator. As shown in FIG. 10, at step 1010, a first group of baseband symbols is mapped to a first one of a plurality of frequency subbands and a second group of baseband symbols is mapped to a second one of the plurality of frequency subbands.

At step 1020, the first group of baseband symbols and the second group of baseband symbols are processed to generate a first signal. The first signal may be a composite signal that is based on a first sequence associated with the first one of the plurality of frequency subbands and based on a second sequence associated with the second one of the plurality of frequency subbands. At step 1030, the first signal is transmitted using a first set of time resources.

At step 1040, it is determined that a first one or more of a plurality of devices are capable of receiving a transmission using one of the plurality of frequency subbands and that a second one or more of the plurality of devices are not capable of receiving a transmission using one of the plurality of frequency subbands. At step 1050, data for the first one or more of the plurality of devices is transmitted using a second set of time resources. The data for each of the one or more devices is transmitted in different ones of the plurality of frequency subbands.

At step 1060, data for one of the second one or more of the plurality of devices is transmitted using a third set of time resources. The data for the one of the second one or more of the plurality of devices is transmitted in a single one of the plurality of frequency subbands.

In some examples, determining that the first one or more of the plurality of devices are capable of receiving a transmission using one of the plurality of frequency subbands may include receiving information from the first one or more of the plurality of devices indicating that the first one or more of the plurality of devices successfully detected at least one of the first sequence or the second sequence. In some examples, determining that the second one or more of the plurality of devices are not capable of receiving a transmission using one of the plurality of frequency subbands may include receiving information from the second one or more of the plurality of devices indicating that the second one or more of the plurality of devices did not successfully detect at least one of the first sequence or the second sequence. In some examples, the determination that the first one or more of the plurality of devices are capable of receiving a transmission using one of the plurality of frequency subbands may be based on at least one indication received from the first one or more of the plurality of devices during an inventory procedure. In some examples, a select message may be transmitted to the first one or more of the plurality of devices based on the determination that the first one or more of the plurality of devices are capable of receiving a transmission using one of the plurality of frequency subbands. In some examples information indicating that the first one or more devices successfully detected at least one of the first preamble sequence or the second sequence may be received in a Msg1 transmission. In some examples, the first signal and the second signal are on-off keying (OOK) modulated signals. In some examples, the first one or more of the plurality of devices do not include any one of the second one or more of the plurality of devices. In some examples, the reader may transmit configuration information to one or more of the devices. The configuration information may include an indication of a frequency channel and/or an indication of the plurality of frequency subbands.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed by an Ambient Internet of Things (AIoT) reader, the method comprising:
mapping a first group of baseband symbols to a first one of a plurality of frequency subbands and a second group of baseband symbols to a second one of the plurality of frequency subbands;
processing the first group of baseband symbols and the second group of baseband symbols to generate a first signal, wherein the first signal is a composite signal that is based on a first sequence associated with the first one of the plurality of frequency subbands and based on a second sequence associated with the second one of the plurality of frequency subbands;
transmitting the first signal using a first set of time resources;
determining that a first one or more of a plurality of devices are capable of receiving a transmission using one of the plurality of frequency subbands and a second one or more of the plurality of devices are not capable of receiving a transmission using one of the plurality of frequency subbands;
transmitting, using a second set of time resources, data for the first one or more of the plurality of devices, wherein the data for each of the first one or more devices is transmitted in different ones of the plurality of frequency subbands; and
transmitting, using a third set of time resources, data for one of the second one or more of the plurality of devices, wherein the data for the one of the second one or more of the plurality of devices is transmitted in a single one of the plurality of frequency subbands.

2. The method of claim 1, wherein determining that the first one or more of the plurality of devices are capable of receiving a transmission using one of the plurality of frequency subbands includes receiving, from the first one or more of the plurality of devices, information indicating that the first one or more of the plurality of devices successfully detected at least one of the first sequence or the second sequence.

3. The method of claim 1, wherein determining that the second one or more of the plurality of devices are not capable of receiving a transmission using one of the plurality of frequency subbands comprises receiving, from the second one or more of the plurality of devices, information indicating that the second one or more of the plurality of devices did not successfully detect at least one of the first sequence or the second sequence.

4. The method of claim 1, wherein the determination that the first one or more of the plurality of devices are capable of receiving a transmission using one of the plurality of frequency subbands is based on at least one indication received from the first one or more of the plurality of devices during at least one step of an inventory procedure performed by the AIoT reader.

5. The method of claim 1, comprising transmitting a select message to the first one or more of the plurality of devices based on the determination that the first one or more of the plurality of devices are capable of receiving a transmission using one of the plurality of frequency subbands.

6. The method of claim 2, wherein the information indicating that the first one or more devices successfully detected at least one of the first sequence or the second sequence is received in a Msg1 transmission.

7. The method of claim 1, wherein the first signal and the second signal are on-off keying (OOK) modulated signals.

8. The method of claim 1, wherein the first one or more of the plurality of devices do not include any one of the second one or more of the plurality of devices.

9. The method of claim 1, wherein the ambient Internet of Things (AIoT) reader is one of a wireless transmit/receive unit (WTRU), a base station, or a network node.

10. The method of claim 1, further comprising transmitting configuration information to the plurality of devices, the configuration information indicating the plurality of frequency subbands.

11. An Ambient Internet of Things (AIoT) reader comprising:
a processor configured to map a first group of baseband symbols to a first one of the plurality of frequency subbands and a second group of baseband symbols to a second one of the plurality of frequency subbands;
the processor configured to process the first group of baseband symbols and the second group of baseband symbols to generate a first signal, wherein the first signal is a composite signal that is based on a first sequence associated with the first one of the plurality of frequency subbands and based on a second sequence associated with the second one of the plurality of frequency subbands;
the processor and a transceiver configured to transmit the first signal using a first set of time resources;
the processor configured to determine that a first one or more of a plurality of devices are capable of receiving a transmission using one of the plurality of frequency subbands and a second one or more of the plurality of devices are not capable of receiving a transmission using one of the plurality of frequency subbands;
the processor and the transceiver configured to transmit, using a second set of time resources, data for the first one or more of the plurality of devices, wherein the data for each of the first one or more devices is transmitted in different ones of the plurality of frequency subbands; and
the processor and the transceiver configured to transmit, using a third set of time resources, data for one of the second one or more of the plurality of devices, wherein the data for the one of the second one or more of the plurality of devices is transmitted in a single one of the plurality of frequency subbands.

12. The AIoT reader of claim 11, wherein determining that the first one or more of the plurality of devices are capable of receiving a transmission using one of the plurality of frequency subbands includes receiving, from the first one or more of the plurality of devices, information indicating that the first one or more of the plurality of devices successfully detected at least one of the first sequence or the second sequence.

13. The AIoT reader of claim 11, wherein determining that the second one or more of the plurality of devices are not capable of receiving a transmission using one of the plurality of frequency subbands comprises receiving, from the second one or more of the plurality of devices, information indicating that the second one or more of the plurality of devices did not successfully detect at least one of the first sequence or the second sequence.

14. The AIoT reader of claim 11, wherein the determination that the first one or more of the plurality of devices are capable of receiving a transmission using one of the plurality of frequency subbands is based on at least one indication received from the first one or more of the plurality of devices during at least one step of an inventory procedure performed by the AIoT reader.

15. The AIoT reader of claim 11, the processor and the transceiver configured to transmit a select message to the first one or more of the plurality of devices based on the determination that the first one or more of the plurality of devices are capable of receiving a transmission using one of the plurality of frequency subbands.

16. The AIoT reader of claim 12, wherein the information indicating that the first one or more devices successfully detected at least one of the first preamble sequence or the second sequence is received in a Msg1 transmission.

17. The AIoT reader of claim 11, wherein the first signal and the second signal are on-off keying (OOK) modulated signals.

18. The AIoT reader of claim 11, wherein the first one or more of the plurality of devices do not include any one of the second one or more of the plurality of devices.

19. The AIoT reader of claim 11, wherein the AIoT reader is one of a wireless transmit/receive unit (WTRU), a base station, or a network node.

20. The AIoT reader of claim 11, the processor and the transceiver further configured to transmit configuration information to the plurality of devices, the configuration information indicating the plurality of frequency subbands.
